(19) United States
(12) Patent Application Publication
(10) Pub. No.: US 2010/0289415 A1
(43) Pub. Date: Nov. 18, 2010

(54) Energy efficient decorative lighting

(76) Inventor: Johnny Chen, Taipei (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/454,480

(22) Filed: May 18, 2009

(51) Int. Cl. H05B 37/02

(52) U.S. Cl. 315/185 R

(57) ABSTRACT

Energy efficient system for lighting is provided that allows variation of length, density of illumination and positioning. The inventive system is particularly suitable for decorative lighting and seasonal display. The lighting system comprises at least one light string having a plurality of light emitting diodes (LEDS) interconnected to a parallel set of power wires maintaining output voltage within a prescribed range. A direct current (DC) transformer is connected to the parallel set of power wires to convert alternating current (AC) input to DC output to control power to the lighting system at relatively low voltage level and less than about fifteen watts. Multiple LED light strings may be connected to the parallel set of power wires to provide decorative lighting displays of desired length, configuration and density of illumination. Accordingly, the unique system provides decorative lighting that is energy efficient and suitable for low cost manufacture compared with conventional incandescent light strings.

### BACKGROUND OF THE INVENTION

The present invention relates to decorative lighting systems, and more particularly to light string circuits including a transformer for conversion of electricity from AC to DC providing prescribed voltages to power multiple LED light sets.

Decorative lighting for temporary and seasonal displays has typically been centered around the use of multiple incandescent light bulbs, such as Christmas Tree lighting. Generally, such conventional lighting is composed of relatively long strings of insulated copper wire carrying multiple lamp bases, lamp holders and incandescent light bulbs. These light strings are usually provided with a plug that is powered by AC household current. As consumers have become much more conscious of the need to conserve energy and to ensure the lighting provides a safe display, those skilled in the art have sought alternative ways to accomplish these goals.

In this respect, light emitting diodes (LEDs) have gained popularity, but in relatively limited display forms e.g. control panels for appliances, decorative displays of relatively small size and the like. However, LEDs have a recognized advantage compared to incandescent light bulbs, in that LEDs are much more energy efficient using just a small fraction of the energy required for incandescent lighting.

A variety of power supply controllers have also been proposed to improve the efficient use of electricity and to provide a safe environment for children that may be attracted to electrical plugs or outlets.

Rapeanu in U.S. Pat. No. 7,362,599 B2 discloses a switching power supply including a bridge rectificer, a switching device, and a controller. The bridge rectifier is operatively coupled to an alternating current (ac) signal, and outputs a rectified signal. The switching device is electrically connected in parallel with the bridge rectifier. The controller is responsive to the rectified signal and selectively controls the switching device to divert at least a portion of the rectified signal therethrough in response to the rectified signal. A method of supply power includes coupling a bridge rectifier operatively to an alternating current (ac) signal, the bridge rectifier outputting a rectified signal, coupling a switching device electrically in parallel with the bridge rectifier, and controlling the switching device to divert at least a portion of the rectified signal therethrough in response to the rectified signal.

Sun in U.S. Pat. No. 7,335,055 B2 discloses an apparatus including a direct current (DC) transformer, a plug, a plurality of electrical outlets, a plurality of switches corresponding to the electrical outlets, a plurality of relays, a fuse, and a diode. Each of the relays correspondingly controls each of the switches. The plug is connected to an input terminal of the DC transformer. The plug is also connected to the electrical outlets via corresponding switches. An anode output terminal of the DC transformer is connected to a cathode of the diode and one each of each of the relays via the fuse. A cathode output terminal of the DC transformer is connected to an anode of the diode and another end of each of the relays.

Kretner in U.S. Pat. No. 7,257,466 B2 discloses a control device which operates to selectively provision power. The control device can be implemented as part of an electrical apparatus, such as a computer, television, VCR, hairdryer or other device which operates on AC power. The control device can be also implemented as part of a common power outlet or breaker system typically found in businesses and households.

Vinciarelli in U.S. Pat. No. 6,911,848 B2 discloses low-loss, common-source gate-control topologies may be used to efficiently drive a multiplicity of switches at frequencies great than 1 MHz and over a range of duty cycles, including 50%. The control switches can be controlled at high speed using simple, directly-coupled drive circuitry. The gate control topology provides for ZVS of control switches and of primary and snychronous rectifier switches while also eliminating essentially all losses associated with the charging and discharging of gate capacitances of the primary and synchronous switches. The overall switching losses in the converter are reduced to the conduction losses in the channels of the switches enabling high operating frequencies to be achieved at high conversion efficiency. An inductive clamp circuit may be incorporated across a winding to provide a low-loss, common source gate drive topology for complementary switches having different duty cycles and an aggregate duty cycle less than 100%. Integrated dual drain FETs enable essentially simultaneous switching of clamp and switch circuitry in the gate drive circuitry.

Han in U.S. Pat. No. 6,184,671 B1 discloses a power control apparatus that receives an input power voltage from a power source and supplies a corresponding output power voltage to a device. The apparatus contains a counter, processor, and a switch. The counter inputs a power control signal and outputs a count signal that corresponds to a lapsed time from when the power control signal is input. The processor inputs the count signal and outputs a time signal. The time out signal has a first value if the lapsed time and a predetermined time have a certain relationship, and the time out signal has a second value if the lapsed time and predetermined time do not have the certain relationship: The switch receives the input power voltage from the power source and the time out signal. If the time out signal has the second value, the switch does not output the output power voltage to the device. On the other hand, if the input power voltage is received and the time out signal has the first value, the switch outputs the output power voltage to the device. In addition, a method performed by the power control apparatus is provided.

U.S. Pat. No. 2008/0157688 A1

Strings of lights, that is, plural lights wired together, to be powered from a plug inserted into a wall outlet, are used to decorate Christmas trees and homes. They are used for both interior decorating and exterior decorating.

For a 100-lamp light set, there are typically two types: two series circuits and three series circuits. The light sets both work the same, but the difference between the two is the brightness. One type is normal brightness and the other type is referred to as “super” bright. The difference in lamp brightness is attributable to the lamp voltage. The two series circuits have a lower lamp voltage per lamp (2.5V) i.e., 125/50. Each series circuit has 50 lamps.

The three circuit set has a higher per=lamp voltage of (3.5V), i.e., 125/35, for a much higher voltage and brighter lamp. Each circuit has 35 lamps in it. This means that a “super bright” 100-light set actually has 105 lamps in it.

Prior art light strings have the following parts: (1) an AC plug containing two 3 Amp fuses with 1 line side and 1 neutral side, (2) 6″-7″ interconnecting wires (22 AWG) between each socket in the series; (3) 1 AC receptacle at the end of the set; (4) 1 “return” or neutral line (22 AWG) from the receptacle on the end of the set and then back to the last socket of each circuit in the set until it eventually terminates at the plug; (5) 1 “hot” line (22 AWG) from the plug to the first socket in the first circuit in the set; (6) 1 “hot” line (22 AWG) from the plug to the additional series circuits remaining in the set; (7) plastic light sockets for two wires; (8) plastic light sockets for three wires; (9) two crass electrical terminals per wire; (10) plastic lamp plugs to hold the lamps; and (11) miniature glass lamps.

Another type of prior art light system uses series of small groups of lights in parallel with each other and with a programmable group device. This type of light string is described in U.S. Pat. No. 6,367,952, issued to the present inventor and incorporated herein by reference in its entirety. Each group is in series with each other group. If one ore more lights in a group burns out or is removed, the programmable group device is programmed to maintain the current in the remaining lights of the group at levels prior to the burning out or removal of one or more of the lights.

Throughout the world, there are hundreds of millions of strings of holiday lights sold each year. Collectively, they consume significant amounts of energy and produce significant amounts of heat. Even small reductions in the amount of heat and energy consumed by holiday lighting would be a substantial benefit.

Thus, there remains a continuing need for a better string of holiday lights.

Accordingly, those skilled in the art have recognized a significant need for energy efficient decorative lighting, that can be manufactured at relatively low cost, while also improving safety of the lighting display. The present invention fulfills these needs.

These and other objects, features and advantages of the present invention will become apparent from the following detailed description of illustrative embodiments thereof, which is to be read in connection with the accompanying drawings.

### SUMMARY OF THE INVENTION

Energy efficient system for lighting is provided that allows variation of length, density of illumination and positioning. The inventive system is particularly suitable for decorative lighting and seasonal display. The lighting system comprises at least one light string having a plurality of light emitting diodes (LEDS) interconnected to a parallel set of power wires maintaining output voltage within a prescribed range. A direct current (DC) transformer is connected to the parallel set of power wires to convert alternating current (AC) input to DC output to control power to the lighting system at relatively low voltage level and less than about fifteen watts. Multiple LED light strings may be connected to the parallel set of power wires to provide decorative lighting displays of desired length, configuration and density of illumination. Accordingly, the unique system provides decorative lighting that is energy efficient and suitable for low cost manufacture compared with conventional incandescent light strings.

In one preferred embodiment, a lighting system comprises a direct current (DC) transformer, to convert AC current to DC current as input to power a plurality of LED light strings with voltage less about 30 volts, and wattage of less than 15 watts.

In more detail, the inventive system further comprises a desired number of LED light sets electrically connected to the pair of power base wires in serial fashion (“end-to-end”). A DC transformer provides current to the pair of power wires at maximum 15 watts and 30 volts. The transformer includes an output male connector of specialized 2 prong configuration that is complementary with the power input female receptor disposed at one end of the power base wires. This “Key connector” construction ensures the correct positioning and orientation of the female/male connectors. Each power base wire of the pair is maintained at no more than 15 watts by the transformer.

Under normal operating circumstances, the transformer's electrical output is set at maximum 15 watts and 30 volts. To increase the lumen power of the LEDs, each diode is preferably contained within a surrounding globe that will enhance the inherent LED illumination such as by florescent coating, by prism effect, hologram or other optical effect. Accordingly, the present invention provides decorative lighting that require much less energy use, while at the same time conserving resources, such as electricity, plastic and cooper.

Other advantages and novel features will become more apparent from the following detailed description when taken in conjunction with the accompanying drawings.

### BRIEF DESCRIPTION OF THE DRAWING

FIG. 1A is a perspective view of one embodied form of a transformer in accordance the present invention;

FIG. 1B is a perspective view of a second embodied transformer in accordance with the present invention;

FIG. 2A is a perspective view of a jack and plug connector with prescribed configuration disposed at a distal portion of the transformer to power one or more light strings in accordance with the present invention;

FIG. 2B is a front view of the jack and plug connector shown in FIG. 2B;

FIG. 2C is a schematic view of one or more LED light strings that can be powered by the transformer in accordance with the present invention;

FIG. 2D is a perspective view of the transformer shown in FIG. 1A having the prescribed plug shown in FIG. 2A;

FIG. 3 is a side perspective view illustrating a plurality of light strings for connection to the transformer in one embodied form of the present invention;

FIG. 4 is a another perspective view of a display incorporating a plurality of light strings having LED mounted with individual globes;

FIG. 5A-C are enlarged side views of one embodied form for mounting of LED with a snap fit globe; and

FIGS. 6A and 6B are enlarged side view of an alternate mounting of the LED mounting in a snap fitting without globe in another embodied form of the present invention.

### DESCRIPTION OF THE PREFERRED EMBODIMENTS

Energy efficient system for lighting is provided that allows variation of length, density of illumination and positioning. The inventive system is particularly suitable for decorative lighting and seasonal display. The lighting system comprises at least one light string having a plurality of light emitting diodes (LEDS) interconnected to a parallel set of power wires maintaining output voltage within a prescribed range. A direct current (DC) transformer is connected to the parallel set of power wires to convert alternating current (AC) input to DC output to control power to the lighting system at relatively low voltage level and less than about fifteen watts. Multiple LED light strings may be connected to the parallel set of power wires to provide decorative lighting displays of desired length, configuration and density of illumination. Accordingly, the unique system provides decorative lighting that is energy efficient and suitable for low cost manufacture compared with conventional incandescent light strings.

In one preferred embodiment, a lighting system comprises a direct current (DC) transformer, to convert AC current to DC current as input to power a plurality of LED light strings with voltage less about 30 volts, and wattage of less than 15 watts.

In more detail, the inventive system further comprises a desired number of LED light sets electrically connected to the pair of power base wires in serial fashion (“end-to-end”). A DC transformer provides current to the pair of power wires at maximum 15 watts and 30 volts. The transformer includes an output male connector of specialized 2 prong configuration that is complementary with the power input female receptor disposed at one end of the power base wires. This “Key connector” construction ensures the correct positioning and orientation of the female/male connectors. Each power base wire of the pair is maintained at no more than 15 watts by the transformer.

Under normal operating circumstances, the transformer's electrical output is set at maximum 15 watts and 30 volts. To increase the lumen power of the LEDs, each diode is preferably contained within a surrounding globe that will enhance the inherent LED illumination such as by florescent coating, by prism effect, hologram or other optical effect. Accordingly, the present invention provides decorative lighting that require much less energy use, while at the same time conserving resources, such as electricity, plastic and cooper.

The inventive string or strings of LEDs (light emitting diodes) thus provides an attractive display for holiday lighting, and equivalent in function to strings of mini incandescent lights.

The light string can include a plurality of lights all of which are in electrical connection with each other and with an electrical plug and an electrical receptacle so that, when the plug is connected to a source of electricity, all of the lights light up. The lights of the present string of lights are light-emitting diodes. Light-emitting diodes (LEDs) are solid state, semiconductor devices that emit light of a particular color when a voltage is applied across their terminals. LEDs are diodes so that they conduct electrical current in only one direction and not in the reverse direction.

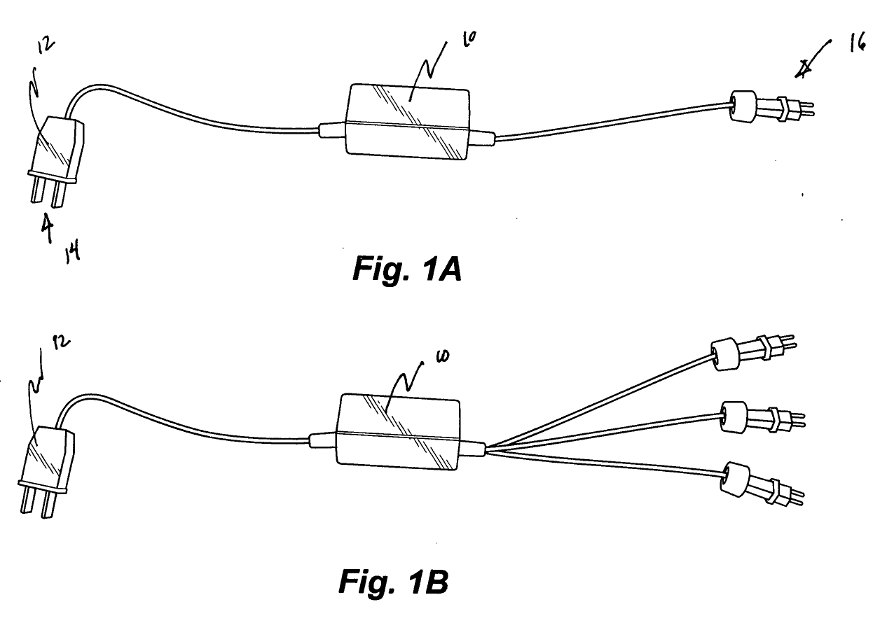

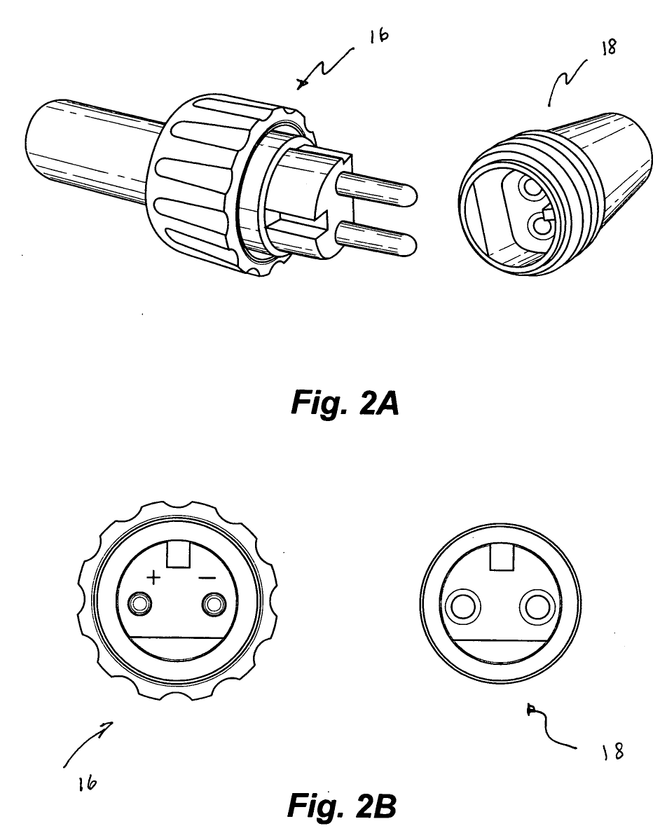

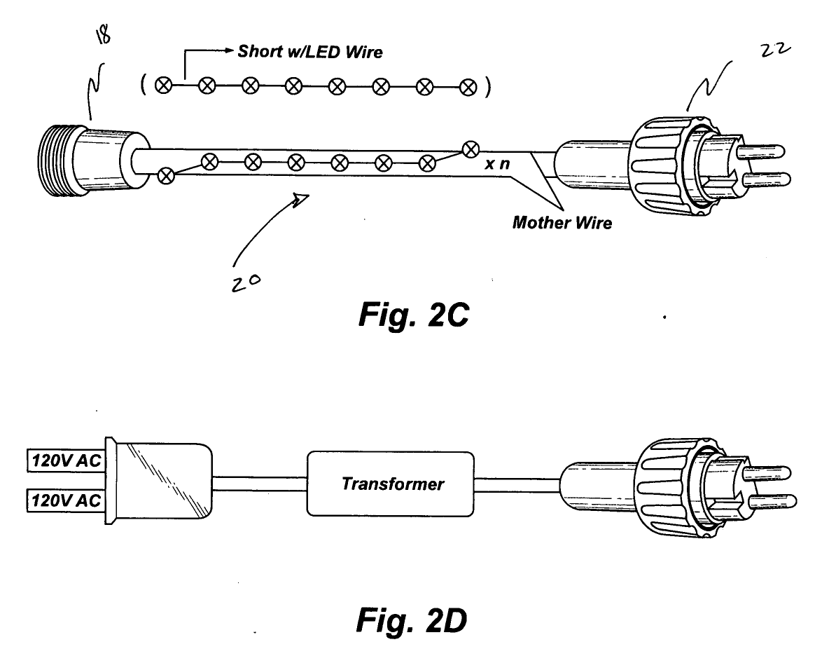

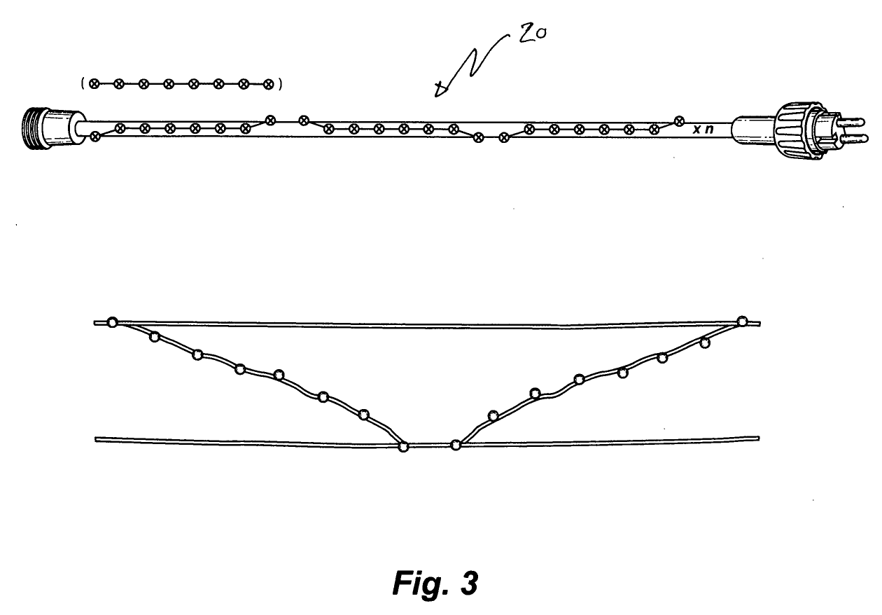

Referring now to FIG. 1, there is illustrated in perspective a preferred embodiment of the present invention. A transformer 10 includes an electrical plug 12 having two terminals 14 that are insertable into a wall socket or other source of electrical current. The distal end of the transformer is provided with one or more electrical plugs 16 to connect LED light strings as seen in FIGS. 2C and 3. Preferably, the electrical plug 16 has a unique outer and or inner housing configuration (FIGS. 2A and 2B). This structure will ensure proper orientation and fit with a complementary jack (receptacle) for physically and electrically connecting the wires in an operative fashion. According the plug 16 is received within the light string receptacle 18 disposed on a terminal end of the light string 20. Accordingly, the end plug 22 of the first light string 20 may be operatively connected to a second light string electrical receptacle (not shown) that can receive another electrical plug from another string of LEDs.

Plug 12 may be conventional alternating current plug or one with a rectifier inside that converts alternating current to direct current and might also have a fuse that limits current to protect string 20 from excessive current. An electrical plug of this type is disclosed in U.S. Pat. No. 5,777,868, and which is incorporated herein in its entirety by reference. However, a preferred alternative is for plug 16 to be part of a string of lights that includes a fused receptacle with a certifying circuit as described in U.S. Pat. No. 6,869,313, as noted above. This receptacle, in addition to having a protective fuse to prevent an overcurrent condition, rectifies the electrical current delivered to the LEDs but passes alternating current from its plug and wires to any string of lights plugged into receptacle.

Still another possibility, as described more fully below, is to not rectify the alternating current but to arrange the LEDs so that some of them are oriented to pass the received electrical current during the first part of the alternating current wave and the remainder of the LEDs are oriented to pass electrical current during the other part of the alternating current wave.

Each light string 20 includes a socket 18 and multiple LEDs 26. At intervals along string 20, programmable group devices (PGDs) maybe connected to the string. Alternatively, PGDs may be incorporated into one socket 22 out of every few sockets 22.

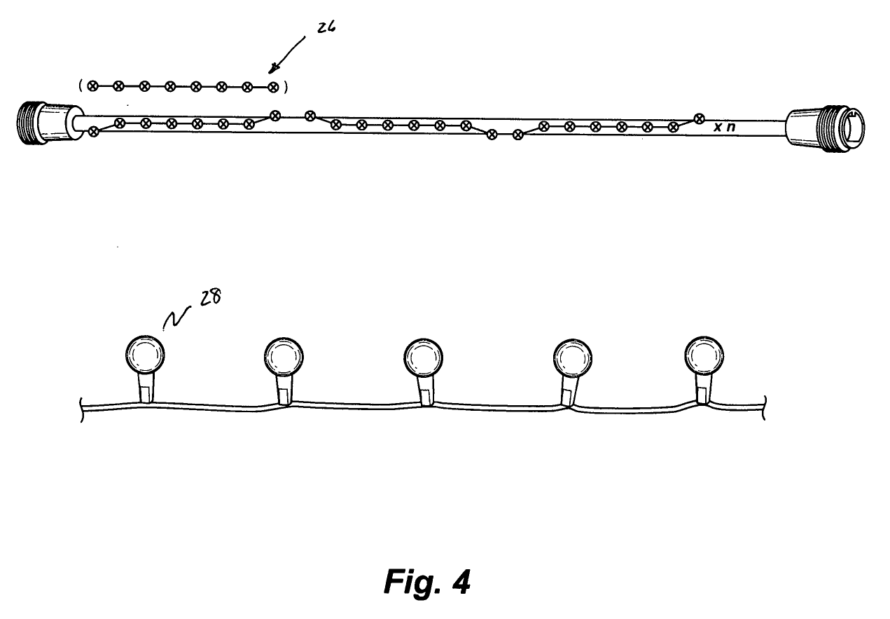

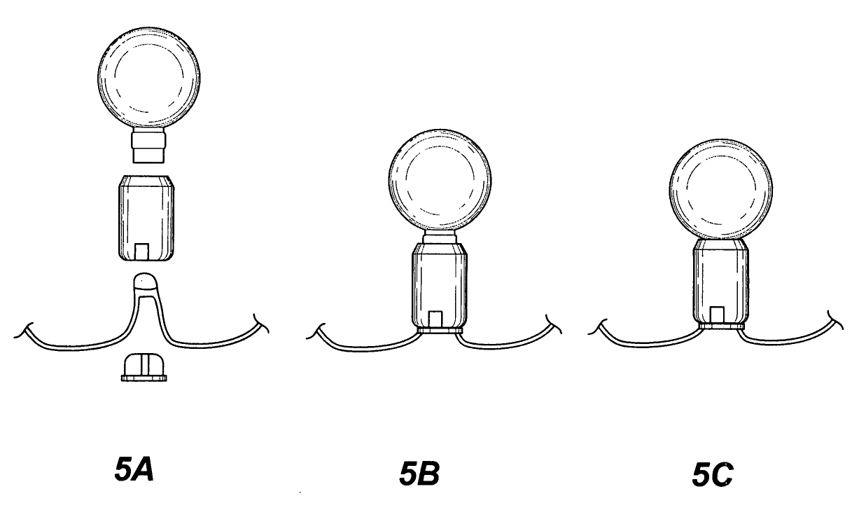

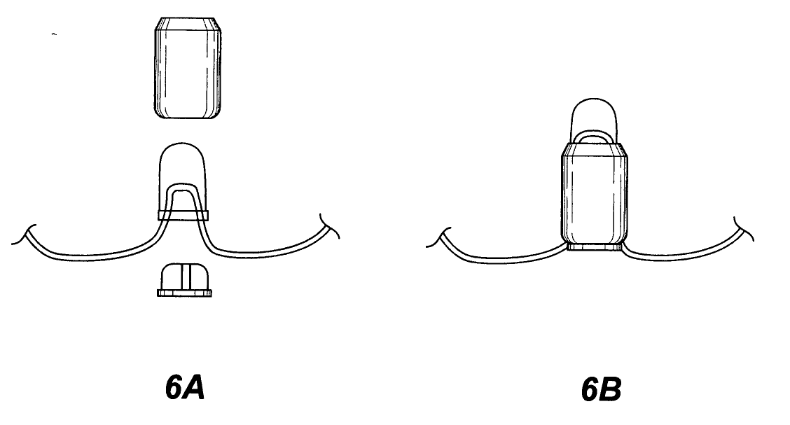

As best seen in FIGS. 4, 5 and 6, LEDs are arranged in groups and the groups connected in electrical series in each string. In an LED string shown in FIG. 4, there are a plurality of LEDs in a group being connected electrically in parallel to the other LEDs. LEDs in each group can draw different currents. Since LEDs of different colors draw different current, this permits the LEDs of different groups to be different colors. For example, red LEDs draw about 20 mA; green LEDs draw about 30 mA; and blue LEDs draw 50 mA. Accordingly, LEDs can be arrange in a group with four diodes all of the same color, such as red, followed by a group including four other LEDs of a different color such as green LEDs followed by four more red ones or four more blue ones, and so on.

PGDs for each group can be designed to operate in connection with the current drawn by the LEDs of that group, that is, a different design PGD for each group color, so that if any of the LEDs burn out or are removed. PGD for that group becomes operational and draws enough current so that no significantly different current is drawn by any of the remaining LEDs of that group and string as a whole does not cease to conduct.

In one embodiment, a parallel group device is composed of an integrated circuit comprised of multiple semiconductor junctions cascaded in a series fashion, or, alternatively, of a bipolar device; the number of semi-conductor junctions is determined by the lamp voltage. If an LED burns out, it contacts degrade or it is removed from its group, the voltage drop across the remaining LEDs of the group changes slightly because of the increased current flow across the remaining lamps and because of the voltage drop due to the resistance of the wire itself.

By using PN junction semiconductors or custom bipolar devices, which have a voltage drop across them of a magnitude that depends on the design and material that the semiconductors are made of, a PGD can be constructed that is pre-programmed to regulate the current flowing through, and the voltage drop across, the group so that it does not exceed a particular level but rather remains constant no matter what happens to an individual lamp 28.

For use with alternating current (AC), the light string 20 device, is preferably a pair of zener diodes arrange in back-to-back orientation that act as voltage regulators. The voltage of the circuit determines how may group there are and the voltage drop of each group determines the voltage characteristics needs for the voltage regulator.

Each group is designed so that a small current passes through the zener diodes at all times, which is characterized as a “partially turned on” state. This state allows them to respond rapidly as a voltage regulator.

Zener diodes characteristically have a sharp turnover or breakdown reverse voltage curve. However, at the start of this curve, they have a small region that is relatively flat wherein they can operate that is not a full “ON” condition. If a zener diode is operated in this part of the characteristic curve, no breakdown will occur, but a small leakage current is typical, indicating proximity to the breakdown or avalanche point. Operating the zener in this region and deliberately keeping it there uses a little more power then when the zener diode is kept out of this region, however, regulation time is shortened. In the design of these parallel groups of lamps operating AC, voltage regulation is of the utmost importance.

The parallel LED groups, being connected in a series fashion, act as a voltage divider and this network becomes a constant current, multi-element, compound circuit. The parallel structure of groups mean that the LEDs cannot have shunts, where in normal series connected miniature light sets, all lamps have shunts in order to keep current flowing throughout the series network in the event of a filament failure. In this parallel LED configuration, the LEDs can fail for any reason, however the parallel group configuration continues to light the remaining lamp if one or more of the aformentioned condition occurs/Due to the fact that this is a complex, multi=element, parallel/series network and series/parallel/series network, the loss of one or more lamps in a parallel group will cause a change in current flow. This current flow decreased across the effected group, therefore decreasing the voltage drop across it, thus increasing the voltage across the effected group. This voltage increase pushes the zener diodes instantly into the breakover region of their characteristic curve and they immediately begin to regulate the voltage in that group by passing current enough to balance the entire network. This keeps the lamps at a constant voltage, thus extending their life considerably.

As shown in FIGS. 4 through 6, the lead may be provide with snap fit mountings with a surrounding globe or without.

It will be apparent to those skilled in the art of electrical light strings that many substitutions and modifications can be made to the preferred embodiments described above without departing from the spirit and scope of the present invention, which is defined by the appended claims.

I claim:

1. A light string for use with a source of electrical current, said light string comprising:
a) an electrical plug;
b) an electrical receptacle;
c) light-emitting diodes arranged in groups interconnected electrically in series and connected in series with said electrical plug said electrical receptacle, each group of said groups having plural sets of light-emitting diodes, each set of said plural sets having at least one light-emitting diode, said plural sets being interconnected electrically in parallel; and
d) a voltage regulator arranged electrically in parallel with said each group, said voltage regulator maintaining electrical current in said plural sets of light-emitting diodes of said each group when said at least one light emitting diode in said each set fails.

2. The light string as recited in claim 1, further comprising a rectifier in electrical connection with said groups for rectifying electrical current to said light emitting diodes when said plug is inserted into a course of electrical current.

3. The light string as recited in claim 2, wherein said rectifier is carried by said receptacle.

4. The light string as recited in claim 1, further comprising a fuse in electrical connection with said light-emitting diodes.

5. The light string as cited in claim 2, further comprising a fuse in electrical connection with said light-emitting diodes and wherein said rectifier and said fuse are carried by said receptacle.
